(19) United States
(12) Patent Application Publication
(10) Pub. No.: US 2005/0081690 A1
(43) Pub. Date: Apr. 21, 2005

(54) Meat cutting band saw

(76) Inventor: Michael J. Biro, Lakeside, OH (US)

Correspondence Address: GIFFORD, KRASS, GROH, SPRINKLE & CITKOWSKI, P.C, PO BOX 7021, TROY, MI, 48007-7021, US

(21) Appl. No.: 10/690,165

(22) Filed: Oct. 21, 2003

(51) Int. Cl. B26D 7/08

(52) U.S. Cl. 83/168; 83/788

(57) ABSTRACT

A cleaning apparatus for a meat cutting band saw having a blade with a cutting flight portion and a return flight portion parallel to each other in which a water delivery manifold extends between the two flights and opposite ends are provided with nozzle assemblies having a pair of nozzles acting at an angle downwardly and against opposed sides of the blade to wash away meat and bone fragments while the saw is in its cutting mode. The cleaning apparatus includes flexible tubular hoses which lend themselves to easy fitting of the apparatus to existing saws.

### FIELD OF THE INVENTION

This invention related to band saws for cutting meat and more particularly to apparatus for cleaning the saw blades while the saw is in operation.

### BACKGROUND OF THE INVENTION

It is important to keep meat clean and free of meat residue resulting from the cutting of the meat to avoid the need to separately clean the cut meat to make it marketable and to avoid contamination. Also it is important to keep the saw blade free of such residue to avoid clogging of the blade and accumulation of meat particles and fats on the drive and guide wheels for the blade which seriously impairs operation and efficiency of the saw.

Various approaches have been taken to cleaning the blades of meat cutting band saws such as scrapers and wipers acting directly on the blade while the saw is in operation. Even with such approaches it is necessary to thoroughly clean and maintain the surrounding parts of the meat cutting saw after each period of use by manually washing and brushing the various components. The patent to Noizet, U.S. Pat. No. 4,608,892 is an example of a saw arrangement in which multiplicity of nozzles are operatively arranged inside the saw housing for spraying cleaning liquid or drying air after a period of use of the saw and while it is not operating.

### SUMMARY OF THE INVENTION

It is an object of the invention to provide apparatus for cleaning a meat cutting band saw while the saw is in operation to avoid contamination of the cut meat, minimize the necessity for manually cleaning and to insure efficient operation of the meat cutting saw.

It is another object of the invention to provide a water cleaning apparatus which can be added to existing meat cutting band saws of various sizes.

Purposes of the invention are attained by cleaning apparatus for a meat cutting band saw in which the saw has a meat cutting table with a drive wheel below the table and a guide wheel above the table together with an endless band saw blade trained over the wheels to provide a downwardly moving meat cutting blade flight and an upwardly moving return flight. A water manifold is disposed rearwardly of the two flights with spaced portions of the manifold in water communication with spray nozzles assemblies each of which has a pair of nozzles directed against opposed portions of each of the two flights. The spray nozzle also is directed downwardly relative to each of the flights, one of which is traveling downwardly and the other which is traveling upwardly.

### DESCRIPTION OF THE DRAWINGS

FIG. 1 is a side elevation of the band saw embodying the invention with panels removed for the purpose of disclosing the operation of the band saw;

FIG. 2 is a perspective view with portions exploded in the interest of disclosure showing the position of the cleaning apparatus relative to portions of the band saw blade;

FIG. 3 is an enlarged view of the downward or cutting direction of the saw blade in the area of the cleansing jets;

FIG. 4 is a view similar to FIG. 3 showing the position of the jets relative to the return flight of the saw blade; and

FIG. 5 is a view of the other side of the saw seen in FIG. 1 with parts broken away.

### DETAILED DESCRIPTION

The wash apparatus of the present invention is incorporated in the meat cutting band saw designated at 10 which includes a lower drive wheel 12 and an upper, idling, guide wheel 14. The wheels 12 and 14 have an endless toothed band saw blade 16 trained over the wheels to form a downwardly moving or cutting flight 18 and an upwardly moving flight 20.

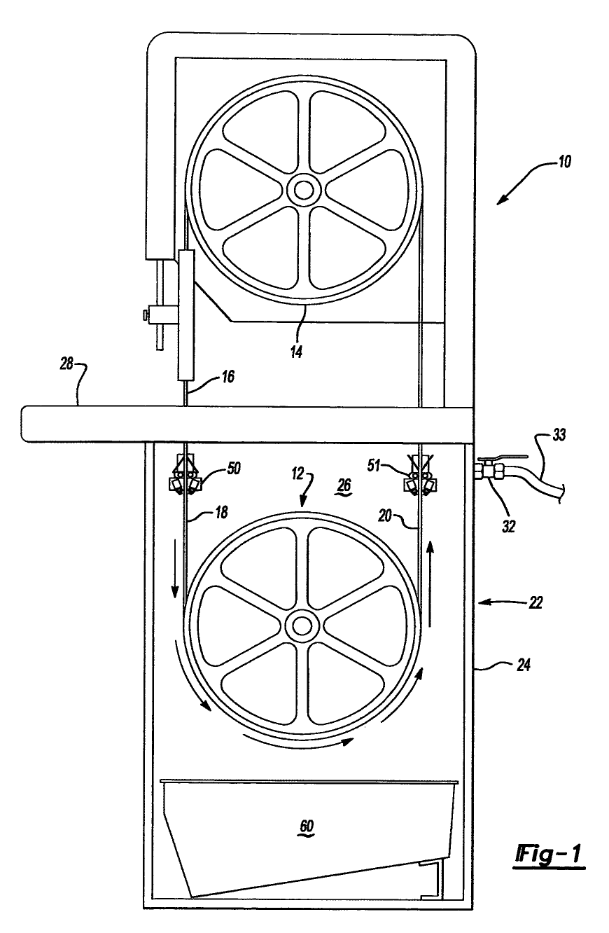

The lower drive wheel 12 is supported in a base 22 which includes a plate or sidewall 24 and a transversely extending center plate or wall 26 which act to support a horizontal cutting table 28. The base 22 also acts to support a standard 30 which extends above the cutting table and supports the guide wheel 14 in elevated relation to the table 28. As viewed in FIG. 1 the saw 10 is illustrated with its side open but in actual operation the saw is closed by panels, not shown, covering and enclosing the base 22 with the drive wheel 12 and the upper guide wheel 14.

The lower drive wheel 12 is supported at one side of wall 26 as seen in FIG. 1 and as seen in FIG. 5 is connected to a drive pulley 29 at the opposite side of wall 26 as seen in FIG. 5 to receive a driving connection with a motor, not shown.

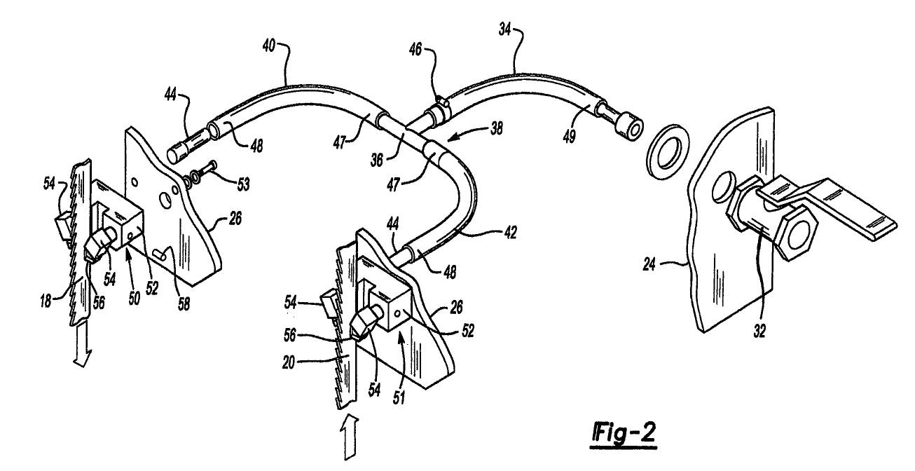

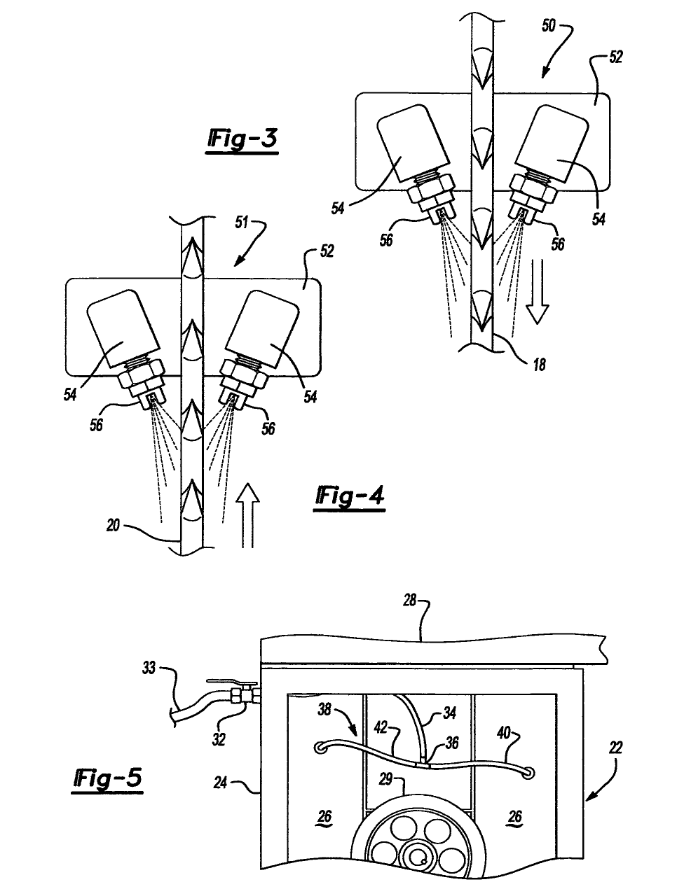

The cleaning apparatus associated with the saw 10 is designated generally at 30 in FIG. 2 and includes a water supply valve 32 connected to a usual water supply line 33. The valve 32 controls the deliver of water to a flexible hose 34 connected to a T-fitting 36 forming part of a water manifold 38 that includes a pair of flexible hoses 40 and 42. The hoses 40 and 42 each have opposite ends connected to a T-fitting 36 and to stems 44. The flexible delivery hose 34 is shown connected to T-fitting 36 by band clamp 46. Similar band clamps 46 are used at the locations indicated at 47, 48, and 49 in FIG. 2 to maintain the flexible hoses in watertight relation to the T-fitting 36 and to their respective stems 44.

A pair of nozzle assemblies 50 and 51 are mounted on the center wall 26 of the base 22 by fasteners 53 one of which is seen in FIG. 2. The pair of nozzle assemblies 50 and 51 are connected in water communication with the pair of stems 44 that pass through the center wall 26 to the manifold 38. Each of the nozzle assemblies 50 and 51 is made up of a water manifold 52 supported in a stationary position on the center wall 26 and having a pair of elbow members 54 threaded into the associated manifold 52. The elbow members 54 are in water communication with the manifolds 52 and associated stems 44 and the free ends of the elbow members 54 are provided with nozzle elements 56 that deliver a spray of water downwardly and to the side of the blade 16. The manifolds 52 and nozzle assemblies 50 and 51 are so arranged that the two pair of nozzle elements 56 are disposed to deliver separate sprays of water on opposite sides of the saw blade flights 18 and 20.

In each case the nozzle elements 56 are directed against the blade 16 and also in a downward direction relative to base 22. However, the direction of the spray relative to the downward blade flight 18 is in the same direction as the blade movement but in the case of the blade flight 20 the spray direction is opposite to the blade movement. This causes a relative increase in spray velocity in the flight 20 over that of flight 18. Also, the angle of the spray relative to the blade 16 can be adjusted by rotating the elbows 54 and locking them in the selected position with set screws, one of which is indicated at 58 in FIG. 2.

In use with the blade 16 moving water can be directed against the moving blades by regulating the valve 32 to the desired degree.

During the cutting operation spray is directed downwardly to wash away meat and bone fragments from the blade toward a collection tray 60 at the bottom of the base 22. The tray 60 may be directly connected to a drain which transports the water and entrained debris away from the saw to a location for further handling.

In addition to the water cleaning during meat cutting operation, an advantage of the present arrangement is that it is readily adaptable to many existing meat cutting saws. The length of the hoses 34, 40 and 42 may be readily shortened or varied to larger lengths to accommodate band saws with different diameter drive and guide wheels 12 and 14, and therefore variations in the spacing of the flights 18 and 20.

A cleaning apparatus for meat cutting band saws has been provided in which each of the two flights of a band saw are cleansed by opposed spray jets acting on opposite sides of the blades and in a downward direction relative to the saw. In the case of the cutting flight or downwardly moving flight the direction of the water spray is in the same direction as the blade movement and in the case of the upward flight or return flight the direction of the water spray is in the opposite direction to blade movement which increases the velocity of the water on the return flight of the blade.

1. Cleaning apparatus for a meat cutting band saw having a cutting table and an endless saw blade trained over a lower drive wheel below said table and an upper guide wheel above said table, said cleaning apparatus comprising:
a source of water;
a nozzle manifold positioned adjacent to said blade and below said table and communicating with said source of water; and
a pair of nozzles connected in water communication to said nozzle manifold and positioned to direct a spray of water downwardly against opposed sides of said blade during movement of the latter.

2. The cleaning apparatus of claim 1 wherein said blade has a downwardly moving flight portion and said nozzle manifold is positioned adjacent to said flight portion to direct water against said blade.

3. The cleaning apparatus of claim 2 wherein said blade has an upwardly moving flight portion parallel to said downwardly moving flight portion, and an additional nozzle manifold is positioned adjacent to said upper moving flight portion to direct water against said blade.

4. The cleaning apparatus of claim 2 and further comprising a support wall below said table, said flight portions and said nozzle manifolds being disposed at one side of said wall and a water supply manifold disposed at the other side of said wall and communicating with said source of water and said nozzle manifolds.

5. Cleaning apparatus for a meat cutting band saw having a meat cutting table and a drive wheel below said table and a guide wheel above said table with a toothed blade trained over said wheels to provide a downwardly moving blade flight portion and an upwardly moving blade flight portion;
a water delivery manifold supported in proximity to said blade and below said table; and
a pair of spray nozzle assemblies communicating with said manifold in closely spaced relation to each of said moving flight portions, each of said pair of assemblies having a pair of nozzles directed against opposite side portions of said downwardly and upwardly moving flight portions.

6. The cleaning apparatus of claim 5 wherein both of said pairs of nozzles are directed downwardly.

7. The cleaning apparatus of claim 6 wherein each of said nozzle assemblies includes a manifold element disposed rearwardly of said blade and a pair of nozzles disposed at opposite sides of said blades.

8. The cleaning apparatus of claim 7 wherein a tray is disposed below said blade to receive spent water and entrained materials.

9. The cleaning apparatus of claim 7 wherein the angles of said nozzles relative to the associated one of said manifold elements is selectively adjustable.

10. Cleaning apparatus for a meat cutting band saw comprising:
a supporting wall having a cutting table at its upper end;
a drive wheel mounted on one side of said wall and below said table;
a guide wheel mounted above said table;
a saw blade trained over said wheels and having a downward moving cutting flight and an upward moving return flight parallel to each other and below said table;
a water delivery manifold in position at the other side of said wall delivering water to spaced points adjacent to said cutting and return flights at the first side of said wall;
a nozzle assembly associated with each of said flights and connected to each of said spaced points; and
a pair of nozzles directing water downwardly and against the opposed sides of the associated cutting and return flights.

11. The cleaning apparatus of claim 10 wherein said water delivery manifold includes a pair of flexible hoses delivering water to said spaced points.

12. The cleaning apparatus of claim 10 wherein a tray is disposed at the lower end of said supporting wall to receive spent spray and materials washed from said blade.
